(19) United States
(12) Patent Application Publication
(10) Pub. No.: US 2026/0176002 A1
(43) Pub. Date: Jun. 25, 2026

(54) CONTROL METHOD AND APPARATUS FOR MOVABLE PLATFORM, AND MOVABLE PLATFORM AND STORAGE MEDIUM

(71) Applicant: SZ DJI TECHNOLOGY CO., LTD., Shenzhen (CN)

(72) Inventors: Xinyu LI, Shenzhen (CN); Qiankun HE, Shenzhen (CN); Xiang XIAO, Shenzhen (CN)

(73) Assignee: SZ DJI TECHNOLOGY CO., LTD., Shenzhen (CN)

(21) Appl. No.: 19/534,544

(22) Filed: Feb. 9, 2026

Related U.S. Application Data
(63) Continuation of application No. PCT/CN2023/120740, filed on Sep. 22, 2023.

(51) Int. Cl. G05D 1/00; B64U 10/13; B66F 9/22; G06F 1/28; G06F 1/3203

(52) U.S. Cl. CPC B64U 10/13; B66F 9/22; G06F 1/28; G06F 1/3203

(57) ABSTRACT

A control method for a movable platform (100) is provided, including: upon detecting that the movable platform (100) has replaced the load, obtaining the current total weight of the movable platform (100) (S101); obtaining the regulatory requirement information matching the current total weight, and adjusting the performance parameters of the movable platform (100) based on the regulatory requirement information (S102). The method enables the movable platform (100), for example a UAV, to better comply with regulatory requirements.

### RELATED APPLICATIONS

This application is a continuation application of PCT application No. PCT/CN2023/120740, filed on Sep. 22, 2023, and the content of which is incorporated herein by reference in its entirety.

### TECHNICAL FIELD

The present disclosure relates to the technical field of movable platforms, and in particular relates to a control method and apparatus for a movable platform, a movable platform, and a storage medium.

### BACKGROUND

At present, unmanned aerial vehicles are widely used in fields such as aerial surveying and mapping, power line inspection, natural gas (oil) pipeline inspection, forest fire prevention, emergency rescue and disaster relief, smart cities, and so on. In different fields, the weights of unmanned aerial vehicles are also different. Moreover, in order to ensure the safe use of unmanned aerial vehicles of different weights, various countries have promulgated different regulations for unmanned aerial vehicles. Therefore, how to enable unmanned aerial vehicles to better comply with regulatory requirements is an urgent problem to be solved at present.

### SUMMARY

Based on this, embodiments of the present disclosure provide a control method and apparatus for a movable platform, a movable platform, and a storage medium. The present disclosure aims to solve the problem of how to enable a movable platform, such as an unmanned aerial vehicle, to better comply with regulatory requirements.

In a first aspect, embodiments of the present disclosure provide a control method for a movable platform capable of carrying replaceable loads of different weights, including: in response to detecting that the movable platform has replaced a load, obtaining a current total weight of the movable platform; and obtaining regulatory requirement information matching the current total weight, and adjusting a performance parameter of the movable platform based on the regulatory requirement information.

In a second aspect, embodiments of the present disclosure provide a control method for a movable platform, including: in response to detecting a change in a total weight of the movable platform, obtaining a current total weight of the movable platform; and obtaining regulatory requirement information matching the current total weight, and adjusting a performance parameter of the movable platform based on the regulatory requirement information.

In a third aspect, embodiments of the present disclosure provide a control device for a movable platform, including: at least one storage medium storing at least one set of instructions; and at least one processor in communication with the at least one storage medium, where during operation, the at least one processor executes the at least one set of instructions to cause the device to perform at least one of a process A or a process B, where the process A includes: in response to detecting that the movable platform has replaced a load, obtaining a current total weight of the movable platform, and obtaining regulatory requirement information matching the current total weight, and adjusting a performance parameter of the movable platform based on the regulatory requirement information; the process B includes: in response to detecting a change in a total weight of the movable platform, obtaining a current total weight of the movable platform, and obtaining regulatory requirement information matching the current total weight, and adjusting a performance parameter of the movable platform based on the regulatory requirement information.

It should be understood that the foregoing general description and the following detailed description are merely exemplary and explanatory, and do not limit the present disclosure.

### BRIEF DESCRIPTION OF THE DRAWINGS

To clearly illustrate the technical solutions of the embodiments of the present disclosure, the accompanying drawings required for use in the description of the embodiments will be briefly introduced below. Obviously, the drawings described below are some exemplary embodiments of the present disclosure. For a person skilled in the art, other drawings may also be obtained based on these drawings without creative effort.

FIG. 1 is a schematic diagram of a scenario for implementing a control method of a movable platform provided by some exemplary embodiments of the present disclosure;

FIG. 2 is a schematic flowchart of steps of a control method for a movable platform provided by some exemplary embodiments of the present disclosure;

FIG. 3 is a schematic flowchart of sub-steps of the control method for a movable platform in FIG. 2;

FIG. 4 is a schematic flowchart of steps of a control method for a movable platform provided by some exemplary embodiments of the present disclosure;

FIG. 5 is a schematic flowchart of steps of a control method for a movable platform provided by some exemplary embodiments of the present disclosure;

FIG. 6 is a schematic flowchart of steps of a control method for a movable platform provided by some exemplary embodiments of the present disclosure;

FIG. 7 is a schematic flowchart of steps of a control method for a movable platform provided by some exemplary embodiments of the present disclosure;

FIG. 8 is a schematic flowchart of steps of a control method for a movable platform provided by some exemplary embodiments of the present disclosure;

FIG. 9 is a schematic flowchart of steps of a control method for a movable platform provided by some exemplary embodiments of the present disclosure;

FIG. 10 is a schematic block diagram of a control apparatus provided by some exemplary embodiments of the present disclosure; and

FIG. 11 is a schematic block diagram of a movable platform provided by some exemplary embodiments of the present disclosure.

### DETAILED DESCRIPTION

The technical solutions of the embodiments of the present disclosure will be described below in conjunction with the accompanying drawings of the embodiments of the present disclosure. It is apparent that the described embodiments are part of the embodiments of the present disclosure, and not all embodiments. Based on the embodiments in the present disclosure, all other embodiments obtained by a person skilled in the art without creative effort shall fall within the scope of protection of the present disclosure.

The flowcharts shown in the drawings are provided for illustrative purposes only. In actual application, it is not necessary to perform all the contents and operations/steps shown in the flowcharts, nor is it necessary to execute them in the described order. For example, some operations/steps may be decomposed, combined, or partially merged, so the actual execution order may change according to the actual situation.

The following provides a detailed description of some exemplary embodiments of the present disclosure in conjunction with the drawings. In the absence of conflict, the following embodiments and features in the embodiments may be combined with each other.

At present, unmanned aerial vehicles are widely used in fields such as aerial surveying and mapping, power line inspection, natural gas (oil) pipeline inspection, forest fire prevention, emergency rescue and disaster relief, smart cities, and so on. In different fields, the weights of unmanned aerial vehicles also vary. Moreover, in order to ensure the safe use of unmanned aerial vehicles of different weights, various countries have promulgated different regulations for unmanned aerial vehicles. Although these regulations can ensure the safe use of unmanned aerial vehicles of different weights, they also impose restrictions on the use of unmanned aerial vehicles of different weights. For example, although the unmanned aerial vehicle initially purchased by a user meets the regulatory requirements of the local region, if the user changes the load of the unmanned aerial vehicle, causing the weight of the unmanned aerial vehicle to increase, the unmanned aerial vehicle no longer meets the regulatory requirements of the local region. Under such conditions, the user cannot use the unmanned aerial vehicle locally, which affects the user experience.

To solve the above problem, some exemplary embodiments of the present disclosure provide a control method and apparatus for a movable platform, a movable platform, and a storage medium. This method, in the case of detecting that the movable platform has changed its load, adjusts the performance parameters of the movable platform based on regulatory requirement information corresponding to the current total weight of the movable platform. After adjusting the performance parameters, the movable platform can comply with the regulatory requirements. This can prevent the issue where the movable platform becomes unusable due to non-compliance after a load change, thereby improving the user experience.

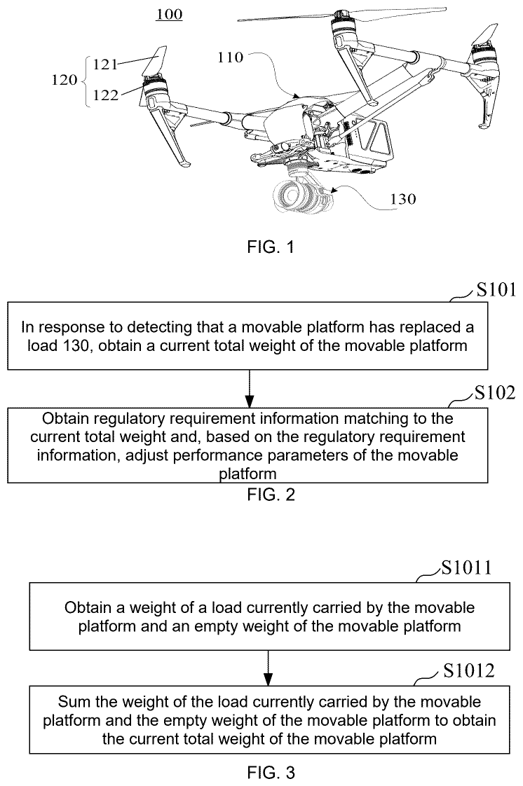

With reference to FIG. 1, FIG. 1 is a schematic diagram of a scenario for implementing a control method of a movable platform provided by some exemplary embodiments of the present disclosure,

As shown in FIG. 1, a movable platform 100 includes a platform body 110, a driving device 120 disposed on the platform body 110, a replaceable load 130, and a control system (not shown in FIG. 1). The platform body 110 is configured to carry replaceable loads 130 of different weights. The load 130 includes one or more of the following: a battery, a propeller guard, a lens, a solar panel, a lighting device, a camera, a radar device, a loudspeaker, a material dropper, a water sampler, or a sonar device. The driving device 120 is configured to provide driving power for the movable platform 100. The control system is configured to control the movable platform 100.

In some exemplary embodiments, the driving device 120 may include one or more propellers 121, one or more motors 122 corresponding to the one or more propellers 121, and one or more electronic speed controllers (referred to as ESCs). The motor 122 is connected between the electronic speed controller and the propeller 121; the motor 122 and the propeller 121 are arranged on the platform body 110 of the movable platform 100; the electronic speed controller is configured to receive a drive signal generated by the control system and provide a drive current to the motor 122 according to the drive signal, so as to control the rotational speed of the motor 122. The motor 122 is configured to drive the propeller 121 to rotate, thereby providing power for the movement of the movable platform 100. This power enables the movable platform 100 to achieve movement along one or more degrees of freedom. In some exemplary embodiments, the movable platform 100 may rotate around one or more rotational axes. For example, the aforementioned rotational axes may include a roll axis, a yaw axis, and a pitch axis. It should be understood that the motor 122 may be a direct current motor or an alternating current motor. In addition, the motor 122 may be a brushless motor or a brushed motor.

In some exemplary embodiments, the control system includes a control device and a sensing system. The sensing system is configured to measure the attitude information of the movable platform 100, that is, the position and state information of the movable platform 100 in space, for example, three-dimensional position, three-dimensional angles, three-dimensional velocity, three-dimensional acceleration, and three-dimensional angular velocity. The sensing system may include at least one of the following sensors: a gyroscope, an ultrasonic sensor, an electronic compass, an Inertial Measurement Unit (IMU), a vision sensor, a Global Navigation Satellite System, and a barometer. For example, the Global Navigation Satellite System may be a Global Positioning System (GPS). The control device is configured to control the movement of the movable platform 100. For example, the movement of the movable platform 100 may be controlled based on the attitude information measured by the sensing system. It should be understood that the control device may control the movable platform 100 according to pre-programmed instructions.

In some exemplary embodiments, upon detecting that the movable platform 100 has replaced the load 130, the control device is capable of obtaining the current total weight of the movable platform 100 and matching regulatory requirement information based on the total weight. According to the regulatory requirement information, the control device can adjust the performance parameters of the movable platform 100. For example, when a user replaces the first battery in the movable platform 100 with a second battery, since the weight of the first battery is greater than that of the second battery, the movable platform 100 can detect that its battery has been replaced. Based on the regulatory requirement information corresponding to the current total weight of the movable platform 100, the control device can adjust the performance parameters of the movable platform 100 so that the movable platform, after the performance parameters are adjusted, complies with regulatory requirements. This can prevent the issue where replacing the battery causes the movable platform 100 to fail to meet regulatory requirements, thereby improving the user experience.

In some exemplary embodiments, upon detecting that the total weight of the movable platform 100 has changed, the control device is capable of obtaining the current total weight of the movable platform 100 and matching regulatory requirement information based on the total weight. According to the regulatory requirement information, the control device can adjust the performance parameters of the movable platform 100. For example, when a user replaces the first battery in the movable platform 100 with a second battery, since the weight of the first battery is greater than that of the second battery, the movable platform 100 can detect that its total weight has changed. Based on the regulatory requirement information corresponding to the current total weight of the movable platform 100, the control device can adjust the performance parameters of the movable platform 100 so that the movable platform 100, after the performance parameters are adjusted, complies with regulatory requirements. This can prevent the issue where a change in the total weight of the movable platform 100 causes it to fail to meet regulatory requirements, thereby improving the user experience.

In some exemplary embodiments, the control device is capable of obtaining the current attribute of the movable platform 100. The current attribute of the movable platform 100 may include at least one of the current total weight, current total volume, current model, current type, and current application scenario of the movable platform 100. The control device can, based on the above attributes, obtain regulatory requirement information that matches them, and adjust the performance parameters of the movable platform according to the regulatory requirement information. For example, when the movable platform 100 is powered on, the control device can adjust the performance parameters of the movable platform 100 based on regulatory requirement information corresponding to the current attribute of the movable platform 100. In this way, each time the movable platform 100 is used; it can be ensured that the movable platform 100 complies with regulatory requirements, thereby improving the user experience.

In some exemplary embodiments, the control device is capable of determining whether the current attribute of the movable platform 100 has changed. The current attribute of the movable platform 100 can be associated with the performance of the movable platform 100. In response to a change in the current attribute of the movable platform 100, the control device is capable of obtaining the constraints imposed at the current location of the movable platform 100 and, based on the constraints at the current location, adjusting the performance parameters of the movable platform 100. In some exemplary embodiments, in response to a signal indicating a change in the current attribute of the movable platform 100, the performance parameters of the movable platform 100 are adjusted based on the constraints at the current location. After adjustment, the performance parameters of the movable platform 100 can comply with the constraints at the current location. This can prevent the issue where a change in the attributes of the movable platform 100 causes it to fail to meet the constraints of the current location and become unusable, thereby improving the user experience.

The movable platform 100 may include aircraft, unmanned vehicles, and mobile robots. The aircraft may include unmanned aircraft and manned aircraft. The unmanned aircraft may be rotary-wing unmanned aircraft, such as quadrotor unmanned aircraft, hexarotor unmanned aircraft, or octarotor unmanned aircraft; it may also be fixed-wing unmanned aircraft, or a combination of rotary-wing and fixed-wing unmanned aircraft. According to the application scenario, the aircraft can be classified as aerial aircraft, underwater aircraft, or amphibious aircraft (e.g., flying cars). According to the application industry, unmanned aircraft can be classified as agricultural unmanned aircraft, industrial unmanned aircraft, aerial photography unmanned aircraft, and the like.

Below, the control method of the movable platform 100 provided by some exemplary embodiments of the present disclosure will be described in detail with reference to the scenario in FIG. 1. It should be noted that the scenario in FIG. 1 is provided only to explain the control method of the movable platform 100 provided by some exemplary embodiments of the present disclosure and does not constitute a limitation on the application scenarios of the control method.

With reference to FIG. 2, FIG. 2 is a schematic flowchart of steps of a control method for a movable platform provided by some exemplary embodiments of the present disclosure.

As shown in FIG. 2, the control method of the movable platform includes steps S101 to S102.

Step S101: In response to detecting that a movable platform has replaced a load 130, obtain a current total weight of the movable platform.

In some exemplary embodiments, the movable platform is capable of carrying replaceable loads 130 of different weights. The load 130 may include one or more of the following: a battery, a propeller guard, a lens, a solar panel, a lighting device, a camera, a radar device, a loudspeaker, a material dropper, a water sampler, or a sonar device. The total weight of the movable platform 100 refers to the overall weight of the entire movable platform.

In some exemplary embodiments, prior to step S101, the method further includes: detecting whether the movable platform 100 has replaced the load 130 when the movable platform 100 is powered on. In some exemplary embodiments, by detecting whether the movable platform 100 has replaced the load 130 upon powering on, the replacement status of the load 130 of the movable platform 100 is timely obtained each time it is used. This avoids situations where the performance parameters of the movable platform 100 cannot be adjusted promptly after the load 130 is replaced, thereby improving the user experience.

In some exemplary embodiments, prior to step S101, the method further includes: detecting whether the movable platform 100 has replaced the load 130 while the movable platform 100 is powered on. That is, the movable platform 100 can perform a hot swap of the load 130. In some exemplary embodiments, the movable platform 100 can detect whether the load 130 has been replaced while it is in a powered-on state. The movable platform 100 does not need to go through a power-off and then power-on process to detect whether the user has replaced the load 130, thereby greatly improving the user experience.

In some exemplary embodiments, detecting whether the movable platform has replaced the load may include: obtaining first identification information of a load previously carried by the movable platform and second identification information of a load currently carried by the movable platform. If the first identification information differs from the second identification information, it can be determined that the movable platform 100 has replaced the load 130; if the first identification information is the same as the second identification information, it can be determined that the movable platform 100 has not replaced the load 130.

In some exemplary embodiments, obtaining the current total weight of the movable platform may include: obtaining identification information of the load 130 currently carried by the movable platform; determining the weight of the currently carried load based on the weight corresponding to the load's identification information, and thereby determining the current total weight of the movable platform. For example, since the movable platform locally stores weight information corresponding to different load identification information, after obtaining the identification information of the current load, the movable platform 100 can look up the corresponding weight information based on the identification information. Alternatively, the movable platform can obtain the weight information corresponding to the identification of the currently carried load from a server.

In some exemplary embodiments, obtaining the current total weight of the movable platform may include: obtaining the current total weight of the movable platform based on sensors of the movable platform. The sensor may be configured according to actual conditions. Embodiments of the present disclosure do not specifically limit this. For example, the sensor may be a pressure sensor. The pressure sensor is deployed at the bottom of the movable platform. In some exemplary embodiments, the movable platform can quickly and accurately obtain its current total weight through its own sensors.

In some exemplary embodiments, obtaining the current total weight of the movable platform may also include: obtaining the current rotational speed of the power device of the movable platform; obtaining a preset total weight corresponding to the current rotational speed; and determining the preset total weight as the current total weight of the movable platform. A correspondence between the rotational speed of the power device and the preset total weight may be established in advance. In this way, after obtaining the current rotational speed of the power device of the movable platform, the preset total weight corresponding to the current rotational speed can be obtained based on the correspondence between rotational speed and preset total weight. In some exemplary embodiments, the current total weight of the movable platform can be determined by obtaining the current rotational speed of its own power device. Since no other external components are required, the convenience of obtaining the total weight is greatly improved.

In some exemplary embodiments, as shown in FIG. 3, step S101 includes sub-steps S1011 to S1012.

Sub-step S1011: Obtain a weight of a load currently carried by the movable platform and an empty weight of the movable platform.

In some exemplary embodiments, the empty weight of the movable platform refers to the total weight of the movable platform when it is not carrying any load. The empty weight of the movable platform may be written into the storage of the movable platform during manufacturing. In this way, the empty weight corresponding to the identification information of the movable platform can be directly obtained later from the storage or from a server.

In some exemplary embodiments, obtaining the weight of the load currently carried by the movable platform may include: obtaining the weight of the currently carried load based on sensors of the movable platform. The sensor may be configured according to actual conditions. Embodiments of the present disclosure do not specifically limit this. In some exemplary embodiments, the movable platform can quickly and accurately obtain the weight of the currently carried load through its own sensors.

In some exemplary embodiments, obtaining the weight of the load currently carried by the movable platform may include: obtaining identification information of the load currently carried by the movable platform; and obtaining the weight of the currently carried load based on the identification information. The identification information of the load is used to uniquely identify the load. For example, the identification information may be a unique identifier code of the load. In some exemplary embodiments, the weight of the currently carried load of the movable platform can be accurately obtained through the identification information of the load currently carried by the movable platform.

In some exemplary embodiments, obtaining the weight of the load currently carried by the movable platform based on the identification information of the load may include: obtaining a labeled weight corresponding to the identification information from a preset mapping table and determining the labeled weight as the weight of the load currently carried by the movable platform. The preset mapping table is used to describe the correspondence between different identification information and different labeled weights, with identification information corresponding to labeled weight. In some exemplary embodiments, the movable platform stores a mapping table describing the correspondence between different identification information and different labeled weights. In this way, by identifying the identification information of the currently carried load and querying the mapping table, the weight of the load currently carried by the movable platform can be quickly obtained. Since no additional external components are required to determine the weight of the load, the convenience of obtaining the load weight is greatly improved.

In some exemplary embodiments, obtaining the weight of the load currently carried by the movable platform based on the identification information of the load may include: the movable platform sending a weight query request carrying the identification information of the load currently carried by the movable platform to a server; the server, upon receiving the weight query request, sending the labeled weight corresponding to the identification information in the weight query request to the movable platform; and the movable platform obtaining the labeled weight returned by the server based on the weight query request and determining the labeled weight as the weight of the load currently carried by the movable platform. In some exemplary embodiments, the server stores a mapping table describing the correspondence between different identification information and different labeled weights. Since the movable platform does not need to store the mapping table, the storage space of the movable platform is saved. At the same time, by identifying the identification information of the currently carried load, the corresponding weight of the load can be queried from the server. Since no additional external components are required to determine the weight of the load, the convenience of obtaining the load weight is greatly improved.

Sub-step S1012: Sum the weight of the load currently carried by the movable platform and the empty weight of the movable platform to obtain the current total weight of the movable platform.

In some exemplary embodiments, the current total weight of the movable platform can be determined based on the weight of the load currently carried and the empty weight of the movable platform. Since no additional external components are required to determine the current total weight, the convenience of obtaining the total weight is greatly improved.

Step S102: Obtain regulatory requirement information matching to the current total weight and, based on the regulatory requirement information, adjust performance parameters of the movable platform.

In some exemplary embodiments, the movable platform adjusts its performance parameters based on the regulatory requirement information corresponding to its current total weight only when it detects that its load has been replaced. This can effectively reduce the number of adjustments to its performance parameters, thereby reducing the power consumption of the movable platform.

In some exemplary embodiments, obtaining the regulatory requirement information matching the current total weight may include: determining the preset weight range to which the current total weight belongs; querying a preset mapping table to obtain the regulatory requirement information corresponding to the preset weight range to which the current total weight belongs; and determining the queried regulatory requirement information as the regulatory requirement information matching the current total weight. Herein, the preset mapping table is used to describe the correspondence between weight range and regulatory requirement information.

For example, the movable platform can be an unmanned aerial vehicle (UAV)/drone, and the UAV is capable of replaceably carrying batteries of different weights. Suppose that when the UAV carries a light-weight battery, the current total weight of the UAV is less than 250 grams. The regulatory requirement that a UAV with a weight less than 250 grams must meet is: “the maximum level flight speed of a UAV weighing less than 250 grams does not exceed 20 km/h, and the maximum flight altitude does not exceed 30 meters.” Accordingly, the flight speed limit of the UAV can be adjusted to 18 km/h (less than or equal to 20 km/h), and the flight altitude limit can be adjusted to 25 meters (less than or equal to 30 meters).

When the user replaces the battery carried by the UAV from a light-weight battery to a heavy-weight battery, the UAV can detect that it has replaced the battery. Suppose that when the UAV carries a heavy-weight battery, the current total weight of the UAV is greater than 250 grams. The regulatory requirement that a UAV with a weight greater than 250 grams must meet is: “the maximum level flight speed of a UAV weighing more than 250 grams does not exceed 50 km/h, and the maximum flight altitude does not exceed 90 meters.” Accordingly, the flight speed limit of the UAV can be adjusted to 48 km/h (less than or equal to 50 km/h); and the flight altitude limit can be adjusted to 88 meters (less than or equal to 90 meters).

In some exemplary embodiments, the performance parameters of the movable platform may include at least one of the mobile performance parameters and the functional performance parameters. Here, the mobile performance parameters are used to describe the mobile performance of the movable platform. For example, the movement speed and/or movement acceleration of the movable platform. The functional performance parameters are used to describe the functional performance of the movable platform. For example, the lighting function, photography function, radar scanning function, or target tracking function of the movable platform. It is understood that the mobile performance parameters and functional performance parameters differ for different types of movable platforms.

For example, if the movable platform is a logistics robot, the mobile performance parameters may include the movement speed limit (the maximum movement speed of the logistics robot) and the movement acceleration limit (the maximum movement acceleration of the logistics robot), etc. If the movable platform is an aircraft, the performance parameters include at least one of flight performance parameters and functional performance parameters. The flight performance parameters include one or more of the following: flight speed limit (the flight speed of the aircraft during actual flight does not exceed the flight speed limit), flight acceleration limit (the flight acceleration of the aircraft during actual flight does not exceed the flight acceleration limit), flight altitude limit (the flight altitude of the aircraft during actual flight does not exceed the flight altitude limit), return time, landing time, takeoff altitude limit (the altitude of the aircraft at takeoff does not exceed the takeoff altitude limit), or takeoff height limit (the hovering height of the aircraft at takeoff does not exceed the takeoff height limit).

In some exemplary embodiments, the functional performance parameters of the aircraft include one or more of the following: indication information for turning on or off the pilot information broadcast function, indication information for turning on or off the RemoteID broadcast function, indication information for turning on or off the tracking distance limit function of target following, indication information for turning on or off the autonomous flight function, indication information for turning on or off the night no-fly function, indication information for turning on or off the photography function, or the enabled lighting strategy.

In some exemplary embodiments, obtaining the regulatory requirement information matching the current total weight may include: obtaining the current location information of the movable platform; and obtaining the regulatory requirement information matching the current total weight and the current location information. Here, the regulatory requirement information is used to describe the conditions that the performance parameters of the movable platform need to meet; the current location information of the movable platform may include the country or administrative region where the movable platform is currently located. In some exemplary embodiments, the regulatory requirements that the movable platform needs to meet can be queried based on the current total weight of the movable platform and the country or administrative region where the movable platform is currently located. By adjusting the performance parameters of the movable platform, the movable platform can comply with the regulatory requirements for movable platforms issued by different countries or administrative regions.

For example, the movable platform is a UAV, and the current total weight of the UAV is less than 250 grams. The country where the UAV is currently located is China. Therefore, the regulatory requirement information that the movable platform can query is: “the maximum true flight altitude of a UAV weighing less than 250 grams does not exceed 50 meters, and the maximum level flight speed does not exceed 40 km/h.” Accordingly, the flight speed limit of the UAV can be adjusted to 40 km/h or 38 km/h (less than or equal to 40 km/h), and the flight altitude limit can be adjusted to 50 meters or 45 meters (less than or equal to 50 meters).

In another example, the current total weight of the UAV is greater than 250 grams and less than 7 kilograms. The country where the UAV is currently located is China. Therefore, the regulatory requirement information that the movable platform can query is: “for a UAV weighing more than 250 grams and less than 7 kilograms, the maximum true flight altitude does not exceed 120 meters, and the maximum level flight speed does not exceed 100 km/h.” Accordingly, the flight speed limit of the UAV can be adjusted to 95 km/h or 96 km/h (less than or equal to 100 km/h); and the flight altitude limit can be adjusted to 115 meters or 110 meters (less than or equal to 120 meters).

In another example, the current total weight of the UAV is less than 25 kilograms, and the country where the UAV is currently located is the United States. Therefore, the regulatory requirement information that the movable platform can query is: “for a UAV weighing less than 25 kilograms, the maximum true flight altitude does not exceed 122 meters, the maximum level flight speed does not exceed 161 km/h, the RemoteID broadcast function must be enabled, and flight must be conducted during daytime.” Accordingly, the flight speed limit of the UAV can be adjusted to 150 km/h or 160 km/h (less than or equal to 161 km/h); the flight altitude limit can be adjusted to 118 meters or 120 meters (less than or equal to 122 meters); and the RemoteID broadcast function and night no-fly function of the UAV must be enabled.

In another example, the current total weight of the UAV is less than 250 grams, and the UAV is currently located in France (part of the European Union). Therefore, the regulatory requirement information that the movable platform can query is: “For UAVs with a weight less than 250 grams, the maximum level flight speed shall not exceed 19 m/s, the maximum flight altitude shall not exceed 120 meters, and when performing target following, the distance between the followed target and the UAV shall not exceed 50 meters.” Based on this, the UAV's flight speed limit can be adjusted to 18 m/s (less than or equal to 19 m/s), and the flight altitude limit can be adjusted to 118 meters or 115 meters (less than or equal to 120 meters). At the same time, the movable platform shall enable the target-following tracking distance limit function and set the distance between the followed target and the UAV to 45 meters or 48 meters (less than or equal to 50 meters).

In yet another example, when the current total weight of the UAV is less than 250 grams and the UAV is currently located in the administrative region of Hong Kong, the regulatory requirement information that the movable platform can query is: “For UAVs with a weight less than 250 grams, the maximum level flight speed shall not exceed 20 km/h, and the maximum flight altitude shall not exceed 30 meters.” Based on this, the UAV's flight speed limit can be adjusted to 18 km/h (less than or equal to 20 km/h); the flight altitude limit can be adjusted to 25 meters (less than or equal to 30 meters). When the current total weight of the UAV is greater than 250 grams and the UAV is currently located in the administrative region of Hong Kong, the regulatory requirement information that the movable platform can query is: “For UAVs with a weight greater than 250 grams, the maximum level flight speed shall not exceed 50 km/h, and the maximum flight altitude shall not exceed 90 meters.” Based on this, the UAV's flight speed limit can be adjusted to 48 km/h (less than or equal to 50 km/h); the flight altitude limit can be adjusted to 88 meters (less than or equal to 90 meters).

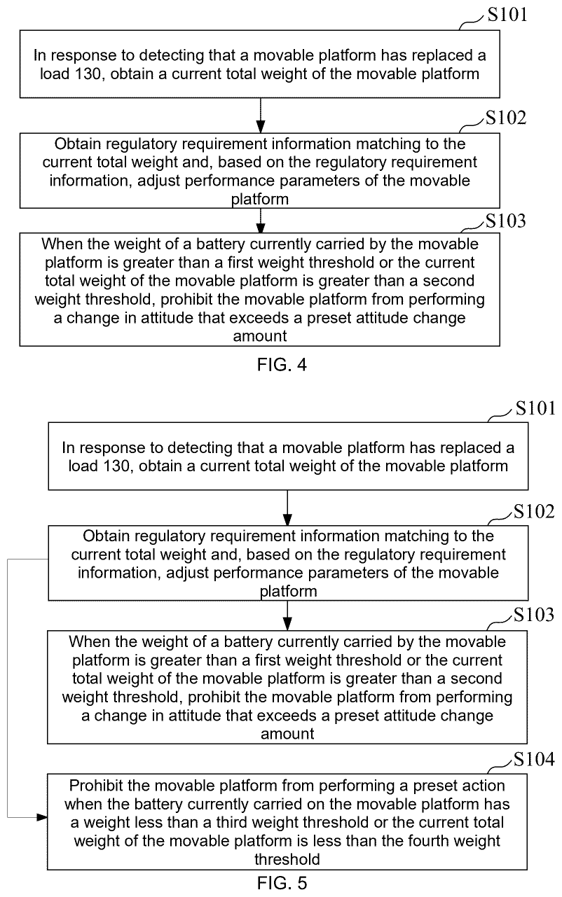

In some exemplary embodiments, the load includes batteries of different weights; and the capacities of the batteries of different weights are different. As shown in FIG. 4, after step S102, the method further includes:

Step S103, When the weight of a battery currently carried by the movable platform is greater than a first weight threshold or the current total weight of the movable platform is greater than a second weight threshold, prohibit the movable platform from performing a change in attitude that exceeds a preset attitude change amount.

In some exemplary embodiments, when the weight of the battery currently carried by the movable platform or the current total weight of the movable platform is relatively large, the movable platform is prohibited from performing large/significant attitude changes. This method can prevent safety issues caused by the movable platform being too heavy during large/significant attitude changes, thereby improving the safety of the movable platform.

For example, the UAV can perform a somersault maneuver or a free-fall maneuver. When performing the somersault maneuver, the UAV is capable of rolling 360° in the vertical direction. When performing the free-fall maneuver, the UAV is capable of descending in the vertical direction and hovering when the descending distance reaches a set distance. However, when the total weight of the UAV is relatively large, the UAV cannot perform the somersault maneuver or the free-fall maneuver well, which may easily cause safety issues. In some exemplary embodiments, by implementing the step of “prohibiting the UAV from performing the somersault maneuver or the free-fall maneuver when the battery currently mounted on the UAV has a relatively large weight or the total weight of the UAV is relatively large,” safety issues caused by excessive UAV weight during the execution of the somersault maneuver or the free-fall maneuver are avoided, thereby improving the safety of the UAV.

It can be understood that the first weight threshold is less than the second weight threshold; and the first weight threshold, the second weight threshold, and the preset attitude change amount can be set based on actual conditions. The embodiments of the present disclosure do not specifically limit this.

In some exemplary embodiments, as shown in FIG. 5, after step S102, the method further includes:

Step S104, Prohibit the movable platform from performing a preset action when the battery currently carried on the movable platform has a weight less than a third weight threshold or the current total weight of the movable platform is less than the fourth weight threshold.

In some exemplary embodiments, the power consumption of the movable platform when performing a preset action is greater than or equal to the preset power consumption. A battery with a small weight also has a small capacity. Therefore, in some exemplary embodiments, when the battery currently mounted on the movable platform or the current total weight of the movable platform is relatively small, it can be known that the capacity of the battery currently mounted on the movable platform is relatively small. In this way, prohibiting the movable platform from performing actions with high power consumption can save power and improve the endurance time of the movable platform.

It can be understood that the third weight threshold is less than the fourth weight threshold; the first weight threshold is greater than the third weight threshold; the second weight threshold is greater than the fourth weight threshold; and the third weight threshold, the fourth weight threshold, the preset power consumption, and the preset action can be set based on actual conditions. The embodiments of the present disclosure do not specifically limit this. For example, the preset action may be a time-lapse photography action (the movable platform performs time-lapse photography) or a circling photography action (the movable platform circles around a target object to perform photography), etc.

In some exemplary embodiments, when the battery currently carried by/mounted on the movable platform has a weight greater than the first weight threshold or the current total weight of the movable platform is greater than the second weight threshold, the movable platform is allowed to perform a preset action, the power consumption of the movable platform when performing the preset action can be greater than or equal to the preset power consumption. In some exemplary embodiments, by “allowing the movable platform to perform the preset action when the capacity of the battery currently mounted on the movable platform is relatively large,” the user experience can be improved.

In some exemplary embodiments, when the battery currently mounted on the movable platform has a weight less than the third weight threshold or the current total weight of the movable platform is less than the fourth weight threshold, the movable platform is allowed to have an attitude change amount exceeding a preset attitude change amount during attitude change. In some exemplary embodiments, by allowing the movable platform to undergo large/significant attitude changes when the weight of the movable platform is relatively small, the user experience can be improved.

In some exemplary embodiments, after step S102, the method further includes: configuring power parameters and attitude parameters of the movable platform according to the weight of the battery currently mounted on the movable platform. The power parameters include one or more of the following: a maximum moving speed, a maximum moving acceleration, a maximum flight altitude, or a maximum rotational speed of a driving device; the attitude parameters include one or more of the following: a maximum attitude angle, an acceleration attitude, a moving attitude, or a braking attitude. In some exemplary embodiments, by adaptively configuring the power parameters and the attitude parameters of the movable platform according to the weight of the battery currently mounted on the movable platform, the movable platform can operate according to more optimal power parameters and attitude parameters, thereby improving the endurance time of the movable platform.

For example, the movable platform includes an aircraft. The power parameters of the aircraft include one or more of the following: a maximum flight speed, a maximum flight acceleration, a maximum flight altitude, or a maximum rotational speed of a driving device; the attitude parameters of the aircraft include one or more of the following: a maximum attitude angle, an aircraft acceleration attitude, a level-flight attitude, or a braking attitude. Among them, the maximum flight speed is less than or equal to a flight limit speed; the maximum flight acceleration is less than or equal to a flight limit acceleration.

In some exemplary embodiments, when the movable platform detects that the user has replaced a replaceable load, the movable platform obtains the current total weight of the movable platform; determines whether the total weight of the movable platform has changed according to the current total weight of the movable platform and a historical total weight stored in a preset register; when the total weight of the movable platform has changed, obtains regulatory requirement information matching the current total weight of the movable platform; and adjusts performance parameters of the movable platform according to the regulatory requirement information. In some exemplary embodiments, the performance parameters of the movable platform are adjusted according to the regulatory requirement information matching the current total weight of the movable platform only when it is detected that the movable platform has replaced the replaceable load and the total weight of the movable platform has changed. In this way, the number of adjustments of the performance parameters of the movable platform can be effectively reduced, thereby reducing the power consumption of the movable platform.

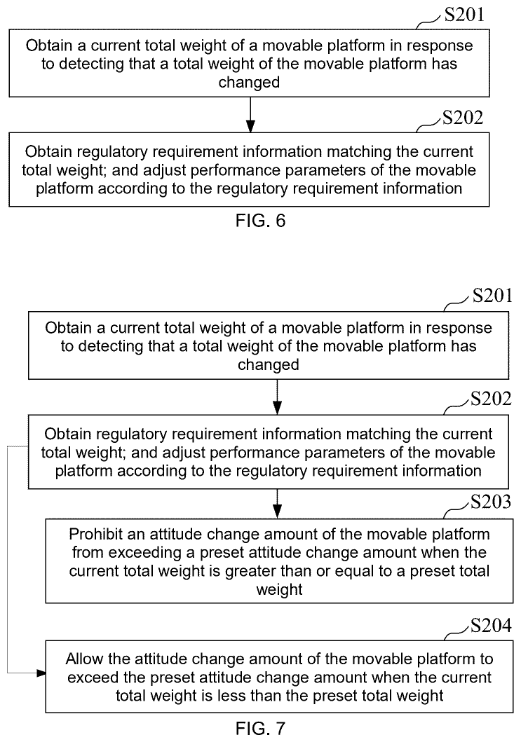

With reference to FIG. 6, FIG. 6 is a schematic flowchart of steps of a control method for a movable platform provided by some exemplary embodiments of the present disclosure.

As shown in FIG. 6, the control method for the movable platform includes steps S201 to S202.

Step S201, Obtain a current total weight of a movable platform in response to detecting that a total weight of the movable platform has changed.

In some exemplary embodiments, a change in the total weight of the movable platform may be caused by the movable platform replacing a replaceable load, or may be caused by the movable platform loading materials or dropping materials. The embodiments of the present disclosure do not specifically limit this.

In some exemplary embodiments, prior to step S201, the method further includes: detecting whether the total weight of the movable platform has changed when the movable platform is powered on. In some exemplary embodiments, when the movable platform is powered on, whether the total weight of the movable platform has changed is detected. Each time the movable platform is used, a change in the total weight of the movable platform can be detected in a timely manner. In this way, situations in which the performance parameters of the movable platform cannot be adjusted in a timely manner after the total weight of the movable platform has changed are avoided, thereby improving the user experience.

In some exemplary embodiments, prior to step S201, the method further includes: detecting whether the total weight of the movable platform has changed when the movable platform is in a powered-on state. In some exemplary embodiments, whether the total weight of the movable platform has changed can be detected when the movable platform is in the powered-on state. Since, in some exemplary embodiments, it is not necessary to power off the movable platform and then power on the movable platform again to detect whether the total weight of the movable platform has changed, the user experience is greatly improved.

In some exemplary embodiments, detecting whether the total weight of the movable platform has changed may include: comparing the current total weight of the movable platform with a historical total weight stored in a preset register; determining that the total weight of the movable platform has not changed when the current total weight of the movable platform is the same as the historical total weight stored in the preset register; and determining that the total weight of the movable platform has changed when the current total weight of the movable platform is different from the historical total weight stored in the preset register. The historical total weight is the total weight of the movable platform at a time prior to the current time.

In some exemplary embodiments, obtaining the current total weight of the movable platform may include: obtaining the current total weight of the movable platform according to a sensor of the movable platform. The sensor may be set based on actual conditions. The embodiments of the present disclosure do not specifically limit this. For example, the sensor may be a pressure sensor. The pressure sensor is deployed at the bottom of the movable platform. In some exemplary embodiments, the current total weight of the movable platform itself can be quickly and accurately obtained through the sensor of the movable platform itself.

In some exemplary embodiments, obtaining the current total weight of the movable platform may also include: obtaining the current rotational speed of a driving device of the movable platform; obtaining a preset total weight corresponding to the current rotational speed; and determining the preset total weight as the current total weight of the movable platform. A correspondence between the rotational speed of the driving device and the preset total weight may be established in advance. In this way, after obtaining the current rotational speed of the driving device of the movable platform, the preset total weight corresponding to the current rotational speed can be obtained based on the correspondence between the rotational speed and the preset total weight. In some exemplary embodiments, the current total weight of the movable platform itself can be determined based on the current rotational speed of the driving device of the movable platform itself. Since it does not rely on other external components for determination, the convenience of obtaining the total weight is greatly improved.

In some exemplary embodiments, obtaining the current total weight of the movable platform may also include: obtaining the weight of the replaceable load currently mounted on the movable platform and the empty weight of the movable platform; summing the weight of the replaceable load currently mounted on the movable platform and the empty weight to obtain the current total weight of the movable platform.

In some exemplary embodiments, obtaining the weight of the replaceable load currently mounted on the movable platform may include: obtaining the weight of the replaceable load currently mounted on the movable platform according to a sensor of the movable platform. The sensor may be set based on actual conditions. The embodiments of the present disclosure do not specifically limit this. In some exemplary embodiments, the weight of the currently mounted replaceable load can be quickly and accurately obtained through the sensor of the movable platform itself.

In some exemplary embodiments, obtaining the weight of the replaceable load currently mounted on the movable platform may include: obtaining identifier information of the replaceable load currently mounted on the movable platform; and obtaining the weight of the replaceable load currently mounted on the movable platform based on the identifier information of the replaceable load currently mounted on the movable platform. The identifier information of the load is used to uniquely identify the load. For example, the identifier information of the load may be a unique identifier code of the load.

In some exemplary embodiments, obtaining the weight of the replaceable load currently mounted on the movable platform based on the identifier information of the replaceable load currently mounted on the movable platform may include: obtaining a labeled weight corresponding to the identifier information from a preset mapping table, and determining the labeled weight as the weight of the replaceable load currently mounted on the movable platform. The preset mapping table is used to describe the correspondence between different identifier information and different labeled weights, and identifier information corresponds to labeled weight.

In some exemplary embodiments, obtaining the weight of the replaceable load currently mounted on the movable platform based on the identifier information of the replaceable load currently mounted on the movable platform may include: the movable platform sending a weight query request carrying the identifier information of the replaceable load currently mounted on the movable platform to a server; the server, upon receiving the weight query request, sending the labeled weight corresponding to the identifier information in the weight query request to the movable platform; and the movable platform obtaining the labeled weight returned by the server based on the weight query request and determining the labeled weight as the weight of the replaceable load currently mounted on the movable platform.

Step S202, Obtain regulatory requirement information matching the current total weight; and adjust performance parameters of the movable platform according to the regulatory requirement information.

In some exemplary embodiments, when a change in the total weight of the movable platform is detected, the performance parameters of the movable platform are adjusted according to regulatory requirement information matching the current total weight of the movable platform. After adjusting the performance parameters, the movable platform can comply with regulatory requirements. In this way, problems caused by changes in the total weight of the movable platform leading to non-compliance with regulatory requirements can be avoided, thereby improving the user experience.

In some exemplary embodiments, the performance parameters of the movable platform may include at least one of the movement performance parameters and the functional performance parameters. The movement performance parameters are used to describe the movement performance of the movable platform. For example, the movement speed and/or movement acceleration of the movable platform. The functional performance parameters are used to describe the functional performance of the movable platform. For example, the lighting device function, photography function, radar scanning function, or target tracking function of the movable platform. It can be understood that the movement performance parameters and functional performance parameters differ for different types of movable platforms.

In some exemplary embodiments, obtaining regulatory requirement information matching the current total weight may include: determining a preset weight range to which the current total weight belongs; querying a preset mapping table to obtain regulatory requirement information corresponding to the preset weight range to which the current total weight belongs; and determining the queried regulatory requirement information as the regulatory requirement information matching the current total weight. The preset mapping table is used to describe the correspondence between weight ranges and regulatory requirement information.

In some exemplary embodiments, obtaining regulatory requirement information matching the current total weight may include: obtaining current location information of the movable platform; and obtaining regulatory requirement information matching the current total weight and the current location information. The regulatory requirement information is used to describe the conditions that the performance parameters of the movable platform need to satisfy; the current location information of the movable platform may include the country or administrative region in which the movable platform is currently located.

In some exemplary embodiments, the step of obtaining regulatory requirement information matching the current total weight and the current location information may include: obtaining a regulatory requirement information table matching the current location information; and obtaining from the regulatory requirement information table the regulatory requirement information matching the current total weight.

In some exemplary embodiments, when the movable platform detects that a change in the total weight is greater than a preset change amount, the movable platform obtains the current total weight of the movable platform. Then, the movable platform obtains regulatory requirement information matching the current total weight, and adjusts the performance parameters of the movable platform according to the regulatory requirement information. The preset change amount can be set based on actual conditions. The embodiments of the present disclosure do not specifically limit this. In some exemplary embodiments, by “adjusting the performance parameters of the movable platform according to regulatory requirement information matching the current total weight of the movable platform when the change in the total weight of the movable platform is greater than the preset change amount,” the number of adjustments of the performance parameters and the power consumption of the movable platform are reduced.

In some exemplary embodiments, as shown in FIG. 7, after step S201, the method further includes:

Step S203, Prohibit an attitude change amount of the movable platform from exceeding a preset attitude change amount when the current total weight is greater than or equal to a preset total weight.

In some exemplary embodiments, the preset total weight and the preset attitude change amount can be set based on actual conditions. The embodiments of the present disclosure do not specifically limit this. In some exemplary embodiments, by “prohibiting the movable platform from undergoing large/significant attitude changes when the current total weight of the movable platform is relatively large,” safety issues caused by the movable platform being too heavy during large/significant attitude changes are avoided, thereby improving the safety of the movable platform.

Step S204, Allow the attitude change amount of the movable platform to exceed the preset attitude change amount when the current total weight is less than the preset total weight.

In some exemplary embodiments, by “allowing the movable platform to undergo large/significant attitude changes when the current total weight of the movable platform is relatively small,” the range of attitude changes of the movable platform is expanded. Since the movable platform is unlocked for more actions, the user experience is improved.

In some exemplary embodiments, after step S202, the method further includes: obtaining the remaining power of the battery of the movable platform; prohibiting the movable platform from performing a preset action when the remaining power is less than a preset power threshold; and allowing the movable platform to perform the preset action when the remaining power is greater than the preset power threshold. The power consumption of the movable platform, when performing the preset action, is greater than or equal to the preset power consumption. In some exemplary embodiments, by “allowing the movable platform to perform the preset action when the remaining power of the battery of the movable platform is relatively high,” the user experience is improved. When the remaining power of the battery of the movable platform is relatively low, the movable platform is prohibited from performing the preset action. In this way, power is conserved, and the endurance time of the movable platform is increased.

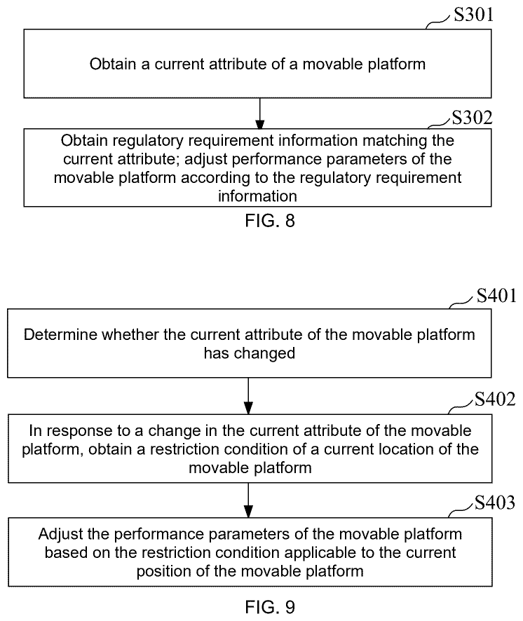

With reference to FIG. 8, FIG. 8 is a schematic flowchart of steps of a control method for a movable platform provided by some exemplary embodiments of the present disclosure.

As shown in FIG. 8, the control method for the movable platform includes steps S301 to S302.

Step S301, Obtain a current attribute of a movable platform.

In some exemplary embodiments, the current attribute of the movable platform may include at least one of the current total weight, current total volume, current model, current type, and current application scenario of the movable platform. Of course, the current attribute of the movable platform may also include other attributes. The embodiments of the present disclosure do not specifically limit this. For example, the current attribute of the movable platform may also include the current dimensions of the movable platform.

In some exemplary embodiments, obtaining the current attribute of the movable platform may include: obtaining the current total weight of the movable platform according to a sensor of the movable platform. Alternatively, obtaining the current attribute of the movable platform may include: obtaining the current rotational speed of a driving device of the movable platform; obtaining a preset total weight corresponding to the current motor rotational speed; and determining the preset total weight as the current total weight of the movable platform. Alternatively, obtaining the current attribute of the movable platform may include: obtaining the weight of the replaceable load currently mounted on the movable platform and the empty weight of the movable platform; and summing the weight of the currently mounted replaceable load and the empty weight to obtain the current total weight of the movable platform.

In some exemplary embodiments, obtaining the weight of the replaceable load currently mounted on the movable platform may include: obtaining identifier information of the replaceable load currently mounted on the movable platform; and obtaining the weight of the replaceable load currently mounted on the movable platform based on the identifier information of the replaceable load currently mounted on the movable platform. The identifier information of the load is used to uniquely identify the load. For example, the identifier information of the load may be a unique identifier code of the load.

In some exemplary embodiments, obtaining the weight of the replaceable load currently mounted on the movable platform based on the identifier information of the replaceable load currently mounted on the movable platform may include: obtaining a labeled weight corresponding to the identifier information from a preset mapping table, and determining the labeled weight as the weight of the replaceable load currently mounted on the movable platform. The preset mapping table is used to describe the correspondence between different identifier information and different labeled weights. One identifier information corresponds to one labeled weight.

In some exemplary embodiments, obtaining the weight of the replaceable load currently mounted on the movable platform based on the identifier information of the replaceable load currently mounted on the movable platform may include: the movable platform sending a weight query request carrying the identifier information of the replaceable load currently mounted on the movable platform to a server; the server, upon receiving the weight query request, sending the labeled weight corresponding to the identifier information in the weight query request to the movable platform; and the movable platform obtaining the labeled weight returned by the server based on the weight query request and determining the labeled weight as the weight of the replaceable load currently mounted on the movable platform.

In some exemplary embodiments, obtaining the current attribute of the movable platform may also include: obtaining identifier information of the movable platform; and obtaining the current attribute of the movable platform based on the identifier information of the movable platform and a pre-stored mapping relationship between identifier information and attributes of the movable platform. The mapping relationship between the identifier information and the attributes of the movable platform is established in advance; the mapping relationship between the identifier information and the attributes of the movable platform can be set based on actual conditions. The embodiments of the present disclosure do not specifically limit this.

Step S302, Obtain regulatory requirement information matching the current attribute; adjust performance parameters of the movable platform according to the regulatory requirement information.

In some exemplary embodiments, by means of “adjusting performance parameters of the movable platform according to regulatory requirement information matching the current attribute of the movable platform”, the function of “adaptively adjusting performance parameters of the movable platform based on regulatory requirement information corresponding to attributes of the movable platform” is achieved. After the performance parameters are adjusted, the movable platform can comply with the regulatory requirement. This effectively avoids the occurrence of the problem that the movable platform does not comply with the regulatory requirement, thereby improving user experience.

In some exemplary embodiments, performance parameters of the movable platform may include at least one of movement performance parameters and functional performance parameters. The movement performance parameters are used to describe movement performance of the movable platform, for example, movement speed and/or movement acceleration of the movable platform. The functional performance parameters are used to describe functional performance of the movable platform. For example, lighting functions, photographing functions, radar scanning functions, or target tracking functions of the movable platform, etc. It can be understood that movement performance parameters and functional performance parameters of different types of movable platforms are different.

In some exemplary embodiments, obtaining regulatory requirement information matching the current total weight may include: determining a preset weight range to which the current total weight belongs; querying a preset mapping relationship table to obtain regulatory requirement information corresponding to the preset weight range to which the current total weight belongs, and determining the queried regulatory requirement information as regulatory requirement information matching the current total weight. The preset mapping relationship table is used to describe a correspondence relationship between weight ranges and regulatory requirement information.

In some exemplary embodiments, obtaining regulatory requirement information matching the current total weight may include: obtaining current location information of the movable platform; obtaining regulatory requirement information matching the current total weight and the current location information. The regulatory requirement information is used to describe conditions that performance parameters of the movable platform need to satisfy, and the current location information of the movable platform may include a country or an administrative region where the movable platform is currently located.

In some exemplary embodiments, obtaining regulatory requirement information matching the current total weight and the current location information may include: obtaining a regulatory requirement information table matching the current location information; and obtaining, from the regulatory requirement information table, regulatory requirement information matching the current total weight.

In some exemplary embodiments, after Step S302, the method further includes: in a case that the current total weight is greater than or equal to a preset total weight, prohibiting an attitude change of the movable platform from exceeding a preset attitude change; or, in a case that the current total weight is less than the preset total weight, allowing an attitude change of the movable platform to exceed the preset attitude change.

In some exemplary embodiments, after Step S302, the method further includes: obtaining a remaining battery power of the movable platform; and, in a case that the remaining battery power is less than a preset power threshold, prohibiting the movable platform from performing a preset action. The power consumption of the movable platform performing the preset action is greater than or equal to a preset power consumption.

Referring to FIG. 9, FIG. 9 is a schematic flowchart of steps of a control method of a movable platform provided in some exemplary embodiments.

As shown in FIG. 9, the control method of the movable platform includes Step S401 to Step S403.

Step S401, Determine whether the current attribute of the movable platform has changed.

In some exemplary embodiments, the current attribute of the movable platform may be associated with performance of the movable platform. For example, the current attribute of the movable platform may include one or more of the following: the current total weight of the movable platform, the current total volume of the movable platform, or the type of load carried by the movable platform.

In some exemplary embodiments, when the movable platform is powered on, it is determined whether the current attribute of the movable platform has changed. In some exemplary embodiments, upon powering on the movable platform, whether the attributes of the movable platform have changed is detected. In this way, each time the movable platform is used, changes in the attributes of the movable platform can be detected in a timely manner. This can avoid a situation where, after the attributes of the movable platform change, the performance parameters of the movable platform cannot be adjusted in time, thereby improving user experience.

In some exemplary embodiments, when the movable platform is in a powered-on state, it is determined whether the current attribute of the movable platform has changed. In some exemplary embodiments, whether the attributes of the movable platform have changed can be detected while the movable platform is in the powered-on state. Since it is not necessary to power off and then power on the movable platform to detect whether its attributes have changed, the user experience is greatly improved.

In some exemplary embodiments, determining whether the current attribute of the movable platform has changed may include: upon detecting that the movable platform has replaced a load, obtaining first identification information of the load before replacement and second identification information of the load currently carried by the movable platform; in a case that load attribute information corresponding to the first identification information is different from load attribute information corresponding to the second identification information, determining that the current attribute of the movable platform has changed; and in a case that the load attribute information corresponding to the first identification information is the same as the load attribute information corresponding to the second identification information, determining that the current attribute of the movable platform has not changed. The load attribute information includes at least one of weight, volume, and type of the load.

In some exemplary embodiments, determining whether the current attribute of the movable platform has changed may include: comparing the current total weight of the movable platform with a historical total weight in a preset register; in a case that the current total weight of the movable platform is the same as the historical total weight in the preset register, determining that the current attribute of the movable platform has not changed; and in a case that the current total weight of the movable platform is different from the historical total weight in the preset register, determining that the current attribute of the movable platform has changed. The historical total weight refers to the total weight of the movable platform prior to the current moment.

Step S402, In response to a change in the current attribute of the movable platform, obtain a restriction condition of a current location of the movable platform.

In some exemplary embodiments, the restriction conditions of the current location of the movable platform may include at least one of the following: restriction conditions on movement performance parameters of the movable platform, restriction conditions on functional performance parameters of the movable platform, or restriction conditions on performance parameters of a load of the movable platform.

In some exemplary embodiments, Step S402 may include: in response to a change in the current attribute of the movable platform, obtaining current location information of the movable platform; and determining the restriction conditions imposed on the current location of the movable platform based on the current location information of the movable platform.

In some exemplary embodiments, the restriction condition applicable to the current position of the movable platform can be determined based on the current position information of the movable platform, which may include: querying and obtaining, from the local storage of the movable platform, the restrictions corresponding to the current position information of the movable platform. The local storage of the movable platform stores restrictions corresponding to different position information. Alternatively, a restriction query request carrying the current position information can be sent to a server; the server sends the restrictions corresponding to the current position information carried by the restriction query request to the movable platform; the movable platform obtains the restriction condition for the current position sent by the server.

In some exemplary embodiments, determining the restriction condition applicable to the current position of the movable platform based on the current position information of the movable platform may include: obtaining the weather information matching the current position information, and determining the restrictions for the current position of the movable platform based on this weather information. For example, the local storage of the movable platform may store restrictions corresponding to different weather information. After obtaining the weather information, the corresponding restrictions are determined based on this weather information. The weather information may include at least one of the following: temperature, humidity, visibility, and wind speed.

Step S403: Adjust the performance parameters of the movable platform based on the restriction condition applicable to the current position of the movable platform.

In some exemplary embodiments, the performance parameters of the movable platform may include at least one of the following: the motion performance parameters of the movable platform and the performance parameters of the movable platform's load. The motion performance parameters of the movable platform may include at least one of the following: movement speed limit, movement altitude limit, and movement acceleration limit.

For example, when a user equips the movable platform with a loudspeaker, the total weight of the movable platform will change. To accommodate the change in the movable platform's weight, the movable platform can determine the movement speed restriction at the current position based on the wind speed at the current position, and adjust the motion performance parameters of the movable platform according to this movement speed restriction. For instance, the movable platform may adjust the movement speed limit and/or movement altitude limit to ensure the safe use of the movable platform.

For example, if a user replaces the loudspeaker in the movable platform with a camera, and the current position of the movable platform is very close to a military-controlled area, the movable platform, in response to the change in load type, obtains the restrictions applicable to its current position as “camera use prohibited” (camera use is prohibited near military-controlled areas). Therefore, the movable platform can be prohibited from using the camera it carries. In this way, the camera carried by the movable platform will remain powered off, and the user will also be unable to control the movable platform to use the camera.

In some exemplary embodiments, it is determined whether the current attribute of the movable platform has changed; in response to a change in the current attribute of the movable platform, the restrictions applicable to the current position of the movable platform are obtained; the current attribute of the movable platform is obtained, and the regulatory requirement information matching the current attribute is obtained; the performance parameters of the movable platform are adjusted based on the restrictions applicable to the current position of the movable platform and the regulatory requirement information matching the current attribute.

In some exemplary embodiments, the performance parameters of the movable platform are adjusted using both the restrictions applicable to the current position of the movable platform and the regulatory requirement information matching the current attribute, so that the movable platform with adjusted performance parameters can simultaneously comply with the restrictions for its current position and the regulatory requirements. This avoids the problem where a change in the attribute of the movable platform causes it to fail to meet the restrictions of the current position or regulatory requirements, thereby improving the user experience.

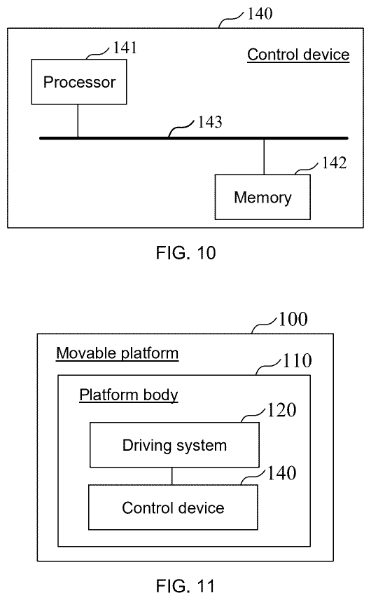

Referring to FIG. 10, FIG. 10 is a schematic diagram illustrating the structure of a control device for a movable platform provided in some exemplary embodiments.

As shown in FIG. 10, the control device 140 of the movable platform includes a processor 141 and a memory 142. The processor 141 and the memory 142 are connected via a bus 143. The bus 143 may be an I2C (Inter-Integrated Circuit) bus.

Specifically, the processor 141 may be a microcontroller unit (MCU), a central processing unit (CPU), or a digital signal processor (DSP), among others.

Specifically, the memory 142 may be a Flash chip, a read-only memory (ROM), a disk, an optical disc, a USB drive, or a portable hard drive, among others.

The processor 141 is configured to execute computer programs stored in the memory 142, and, when executing the computer programs, performs the following steps:
Upon detecting that the movable platform has replaced the load, obtain the current total weight of the movable platform;
Obtain the regulatory requirement information matching the current total weight, and adjust the performance parameters of the movable platform based on the regulatory requirement information.

In some exemplary embodiments, when obtaining the current total weight of the movable platform, the processor 141 is configured to:
Obtain the weight of the load currently carried by the movable platform and the empty weight of the movable platform;
Sum the weight of the load currently carried by the movable platform and the empty weight to obtain the current total weight of the movable platform.

In some exemplary embodiments, when obtaining the weight of the load currently carried by the movable platform, the processor 141 is configured to:
Obtain the weight of the load currently carried by the movable platform based on a sensor of the movable platform.

In some exemplary embodiments, when obtaining the weight of the load currently carried by the movable platform, the processor 141 is configured to:
Obtain the identification information of the load currently carried by the movable platform;
Determine the weight of the load currently carried by the movable platform based on the identification information.

In some exemplary embodiments, when obtaining the weight of the load currently carried by the movable platform based on the identification information, the processor 141 is configured to:
Obtain the labeled weight corresponding to the identification information from a preset mapping table, and determine the labeled weight as the weight of the load currently carried by the movable platform. The preset mapping table is used to describe the correspondence between different identification information and different labeled weights. One identification information corresponds to one labeled.

In some exemplary embodiments, when obtaining the weight of the load currently carried by the movable platform based on the identification information, the processor 141 is configured to:
Send a weight query request carrying the identification information to a server, so that upon receiving the weight query request, the server sends the labeled weight corresponding to the identification information to the movable platform;
Obtain the labeled weight returned by the server based on the weight query request, and determine the labeled weight as the weight of the load currently carried by the movable platform.

In some exemplary embodiments, when obtaining the current total weight of the movable platform, the processor 141 is configured to:
Obtain the current total weight of the movable platform based on a sensor of the movable platform.

In some exemplary embodiments, when obtaining the current total weight of the movable platform, the processor 141 is configured to:
Obtain the current rotational speed of the driving device of the movable platform;
Obtain the preset total weight corresponding to the current rotational speed;
Determine the preset total weight as the current total weight of the movable platform.

In some exemplary embodiments, when obtaining the regulatory requirement information matching the current total weight, the processor 141 is configured to:
Obtain the current position information of the movable platform;
Obtain the regulatory requirement information matching the current total weight and the current position information.

In some exemplary embodiments, the current position information includes the country where the movable platform is currently located.

In some exemplary embodiments, the current position information includes the administrative region where the movable platform is currently located.

In some exemplary embodiments, the movable platform includes a UAV; the performance parameters include at least one of the flight performance parameters and the functional performance parameters of the UAV; the flight performance parameters include one or more of the following: flight speed limit, flight acceleration limit, flight altitude limit, return-to-home time, landing time, takeoff altitude limit, or takeoff height limit.

In some exemplary embodiments, the load 130 includes batteries of different weights, and the batteries of different weights have different capacities. After adjusting the performance parameters of the movable platform 100 based on the regulatory requirement information, the processor 141 is further configured to:
When the weight of the battery currently carried by the movable platform 100 exceeds a first weight threshold or the current total weight of the movable platform exceeds a second weight threshold, prohibit the attitude change of the movable platform from exceeding a preset attitude change amount.

In some exemplary embodiments, after adjusting the performance parameters of the movable platform based on the regulatory requirement information, the processor 141 is further configured to:
When the weight of the battery currently carried by the movable platform is less than a third weight threshold or the current total weight of the movable platform is less than a fourth weight threshold, prohibit the movable platform from performing a preset action. The power consumption of the movable platform, when performing the preset action, is greater than or equal to a preset power consumption.

In some exemplary embodiments, after adjusting the performance parameters of the movable platform based on the regulatory requirement information, the processor 141 is further configured to:
Configure the driving parameters and attitude parameters of the movable platform based on the weight of the battery currently carried by the movable platform. The driving parameters include one or more of the following: maximum movement speed, maximum movement acceleration, maximum movement altitude, or maximum rotational speed of the driving device; the attitude parameters include one or more of the following: maximum attitude angle, acceleration attitude, movement attitude, or braking attitude.

In some exemplary embodiments, the processor 141 is further configured to perform the following steps:
Upon detecting a change in the total weight of the movable platform, obtain the current total weight of the movable platform;
Obtain the regulatory requirement information matching the current total weight, and adjust the performance parameters of the movable platform based on the regulatory requirement information.

In some exemplary embodiments, when obtaining the current total weight of the movable platform upon detecting a change in the total weight of the movable platform, the processor 141 is configured to:
Obtain the current total weight of the movable platform when the detected change in the total weight of the movable platform exceeds a preset change amount.

In some exemplary embodiments, after obtaining the current total weight of the movable platform, the processor 141 is further configured to:
When the current total weight is greater than or equal to a preset total weight, prohibit the attitude change of the movable platform from exceeding a preset attitude change amount;
Alternatively, when the current total weight is less than the preset total weight, allow the attitude change of the movable platform to exceed the preset attitude change amount.

In some exemplary embodiments, after adjusting the performance parameters of the movable platform based on the regulatory requirement information, the processor 141 is further configured to:
Obtain the remaining power of the battery of the movable platform;
When the remaining power is less than a preset power threshold, prohibit the movable platform from performing a preset action. The power consumption of the movable platform, when performing the preset action, is greater than or equal to a preset power consumption.

In some exemplary embodiments, the processor 141 is further configured to perform the following steps:
Obtain the current attribute of the movable platform. The current attribute includes at least one of the following: the current total weight, current total volume, current model, current type, or current application scenario of the movable platform;
Obtain the regulatory requirement information matching the current attribute, and adjust the performance parameters of the movable platform based on the regulatory requirement information.

In some exemplary embodiments, the processor 141 is further configured to perform the following steps:
Determine whether the current attribute of the movable platform has changed. The current attribute is associated with the performance of the movable platform;
In response to a change in the current attribute of the movable platform, obtain the restrictions applicable to the current position of the movable platform; and
Adjust the performance parameters of the movable platform based on the restrictions applicable to the current position of the movable platform.

In some exemplary embodiments, the performance parameters include at least one of the following: the motion performance parameters of the movable platform or the performance parameters of the load of the movable platform.

It should be noted that a person skilled in the art will understand that, for the sake of convenience and brevity, the specific working process of the control device of the movable platform described above can refer to the corresponding process in the aforementioned embodiments of the control method of the movable platform, and is not repeated herein.

Referring to FIG. 11, FIG. 11 is a schematic diagram illustrating the structure of a movable platform provided in some exemplary embodiments.

As shown in FIG. 11, the movable platform 100 includes a platform body 110, a driving device/system 120, and a control device 140. The platform body 110 is configured to carry replaceable loads of different weights; the driving device/system 120 is disposed on the platform body 110 and is configured to provide mobility power for the movable platform 100; the control device 140 is disposed on the platform body 100 and is configured to control the movable platform 100.

It should be noted that a person skilled in the art will understand that, for the sake of convenience and brevity, the specific working process of the movable platform described above can refer to the corresponding process in the aforementioned embodiments of the control method of the movable platform, and is not repeated herein.

Some exemplary embodiments also provide a storage medium for computer-readable storage (a non-transitory computer-readable storage medium storing at least one set of instructions). The storage medium stores a computer program, which includes program instructions. The processor executes the program instructions to implement the steps of the control method of the movable platform provided in the above embodiments.

The storage medium may be an internal storage unit of the movable platform in any of the aforementioned embodiments, such as the hard disk or memory of the movable platform. The storage medium may also be an external storage device of the movable platform, such as a plug-in hard disk, a Smart Media Card (SMC), a Secure Digital (SD) card, a Flash Card, or the like, equipped on the movable platform.

It should be understood that the terms used in this disclosure are solely for the purpose of describing particular embodiments and are not intended to limit the present disclosure. As used in this disclosure and the appended claims, unless the context clearly indicates otherwise, the singular forms “a,” “an,” and “the” are intended to include the plural forms.

It should also be understood that the term “and/or” used in this disclosure and the appended claims refers to any one or more of the items listed, any combination thereof, and all possible combinations, and includes these combinations.

The above description is only of specific embodiments of the present disclosure, and the scope of protection of the present disclosure is not limited thereto. Any person skilled in the art, within the technical scope disclosed in the present disclosure, can readily conceive of various equivalent modifications or substitutions, and such modifications or substitutions should be encompassed within the scope of protection of the present disclosure. Therefore, the scope of protection of the present disclosure shall be defined by the scope of the claims.

What is claimed is

1. A control method for a movable platform capable of carrying replaceable loads of different weights, comprising:
in response to detecting that the movable platform has replaced a load, obtaining a current total weight of the movable platform; and
obtaining regulatory requirement information matching the current total weight, and adjusting a performance parameter of the movable platform based on the regulatory requirement information.

2. The control method according to claim 1, wherein the obtaining the current total weight of the movable platform comprises:
obtaining a weight of a load currently carried by the movable platform and an empty weight of the movable platform; and
summing the weight of the load currently carried by the movable platform and the empty weight to obtain the current total weight of the movable platform.

3. The control method according to claim 2, wherein the obtaining the weight of the load currently carried by the movable platform comprises:
obtaining the weight of the load currently carried by the movable platform based on a sensor of the movable platform.

4. The control method according to claim 2, wherein the obtaining the weight of the load currently carried by the movable platform comprises:
obtaining identification information of the load currently carried by the movable platform; and
obtaining the weight of the load currently carried by the movable platform based on the identification information.

5. The control method according to claim 4, wherein the obtaining the weight of the load currently carried by the movable platform based on the identification information comprises:
obtaining a labeled weight corresponding to the identification information from a preset mapping table, and determining the labeled weight as the weight of the load currently carried by the movable platform, wherein
the preset mapping table defines correspondences between different identification information and different labeled weights, and one piece of identification information corresponds to one labeled weight.

6. The control method according to claim 4, wherein the obtaining the weight of the load currently carried by the movable platform based on the identification information comprises:
sending a weight query request containing the identification information to a server, so that upon receiving the weight query request, the server sends the labeled weight corresponding to the identification information to the movable platform; and
obtaining the labeled weight sent by the server based on the weight query request, and determining the labeled weight as the weight of the load currently carried by the movable platform.

7. The control method according to claim 1, wherein the obtaining the current total weight of the movable platform comprises:
obtaining the current total weight of the movable platform based on a sensor of the movable platform.

8. The control method according to claim 1, wherein the obtaining the current total weight of the movable platform comprises:
obtaining a current rotational speed of a driving device of the movable platform;
obtaining a preset total weight corresponding to the current rotational speed; and
determining the preset total weight as the current total weight of the movable platform.

9. The control method according to claim 1, wherein the obtaining the regulatory requirement information matching the current total weight comprises:
obtaining current position information of the movable platform; and
obtaining regulatory requirement information matching the current total weight and the current position information.

10. The control method according to claim 9, wherein the current position information comprises a country where the movable platform is currently located.

11. The control method according to claim 9, wherein the current position information comprises an administrative region where the movable platform is currently located.

12. The control method according to claim 1, wherein the movable platform comprises an unmanned aerial vehicle (UAV), the performance parameter comprises at least one of a flight performance parameter or a functional performance parameter of the UAV, and the flight performance parameter comprises at least one of a flight speed limit, a flight acceleration limit, a flight altitude limit, a return-to-home time, a landing time, a takeoff altitude limit, or a takeoff height limit.

13. The control method according to claim 1, wherein the load comprises batteries of different weights, and the batteries of different weights have different capacities, after adjusting the performance parameter of the movable platform based on the regulatory requirement information, the method further comprises:
in response to a weight of a battery currently carried by the movable platform being greater than a first weight threshold or the current total weight of the movable platform being greater than a second weight threshold, prohibiting, during an attitude adjustment, an attitude variation of the movable platform from exceeding a preset attitude variation.

14. The control method according to claim 13, wherein after adjusting the performance parameter of the movable platform based on the regulatory requirement information, the method further comprises:
in response to the weight of the battery currently carried by the movable platform being less than a third weight threshold or the current total weight of the movable platform being less than a fourth weight threshold, prohibiting the movable platform from performing a preset action, wherein a power consumption of the movable platform for performing the preset action is greater than or equal to a preset power consumption.

15. The control method according to claim 13, wherein after adjusting the performance parameter of the movable platform based on the regulatory requirement information, the method further comprises:
configuring a driving parameter and an attitude parameter of the movable platform based on the weight of the battery currently carried by the movable platform, wherein
the driving parameter comprises at least one of a maximum movement speed, a maximum movement acceleration, a maximum movement altitude, or a maximum rotational speed, of a driving device, and the attitude parameter comprises at least one of a maximum attitude angle, an acceleration attitude, a movement attitude, or a braking attitude.

16. The control method according to claim 1, wherein the load comprises at least one of a battery, a propeller guard, a lens, a solar panel, a lighting device, a camera, a radar device, a loudspeaker, a material dropper, a water sample collector, or sonar.

17. A control method for a movable platform, comprising:
in response to detecting a change in a total weight of the movable platform, obtaining a current total weight of the movable platform; and
obtaining regulatory requirement information matching the current total weight, and adjusting a performance parameter of the movable platform based on the regulatory requirement information.

18. The control method according to claim 17, wherein the obtaining the regulatory requirement information matching the current total weight comprises:
obtaining current position information of the movable platform; and
obtaining regulatory requirement information matching the current total weight and the current position information.

19. The control method according to claim 17, wherein the movable platform comprises an unmanned aerial vehicle (UAV), the performance parameter comprises at least one of a flight performance parameter or a functional performance parameter of the UAV, and the flight performance parameter comprises at least one of a flight speed limit, a flight acceleration limit, a flight altitude limit, a return-to-home time, a landing time, a takeoff altitude limit, or a takeoff height limit.

20. A control device for a movable platform, comprising:
at least one storage medium storing at least one set of instructions; and
at least one processor in communication with the at least one storage medium, wherein during operation, the at least one processor executes the at least one set of instructions to cause the device to perform at least one of a process A or a process B, wherein
the process A comprises: in response to detecting that the movable platform has replaced a load, obtaining a current total weight of the movable platform, and obtaining regulatory requirement information matching the current total weight, and adjusting a performance parameter of the movable platform based on the regulatory requirement information,
the process B comprises: in response to detecting a change in a total weight of the movable platform, obtaining a current total weight of the movable platform, and obtaining regulatory requirement information matching the current total weight, and adjusting a performance parameter of the movable platform based on the regulatory requirement information.
